(19) United States
(12) Patent Application Publication
(10) Pub. No.: US 2026/0185385 A1
(43) Pub. Date: Jul. 2, 2026

(54) PORTABLE ELECTRONIC LOCK

(71) Applicant: ABUS August Bremicker Söhne KG, Wetter-Volmarstein (DE)

(72) Inventors: Markus Theis, Herborn (DE); Manuel Cornelius Neveling, Wetter (DE)

(21) Appl. No.: 18/726,458

(22) PCT Filed: Dec. 29, 2022
(86) PCT No.: PCT/EP2022/088002

§ 371 Date: Jul. 3, 2024

(30) Foreign Application Priority Data
Jan. 10, 2022 (DE) 10 2022 100 409.0

(51) Int. Cl. E05B 47/00; E05B 67/00

(52) U.S. Cl. CPC E05B 47/0012; E05B 67/00; E05B 2047/0017; E05B 2047/0024; E05B 2047/0036; E05B 2047/0058; E05B 2047/0067; E05B 2047/0095

(57) ABSTRACT

A portable electronic lock comprises a lock body and a securing part, an electric motor, an entrainer, a rotating latch, a return spring, a blocking mechanism, and a control circuit. The rotating latch can, starting from a locking position, be driven by the entrainer against the force of the return spring into an unlocking position in which the securing part is unlocked for a movement into an open position, wherein the entrainer is rotated back into a starting position utilizing a rotational clearance. The blocking mechanism first blocks the rotating latch in the unlocking position against a return movement. By moving the securing part into a closed position, the blocking mechanism is released to trigger an unblocking of the rotating latch and thus a relaxing of the return spring so that the rotating latch is mechanically driven by the return spring to make a return movement into the locking position.

The invention relates to a portable electronic lock comprising a lock body and a securing part that is movable relative to the lock body between a closed position and an open position, wherein the lock body comprises an electromechanical locking device to lock the securing part located in the closed position to the lock body.

In mobile applications, such a lock may serve to secure an object—for example, a two-wheeler—to a stationary object or to immobilize the object. Such a lock may also serve to be selectively attached to a stationary object—for example, to a building door or to a hasp of a building door—in order to secure access.

A portable electronic lock may, for example, be controllable by biometric authentication (e.g. by means of a fingerprint sensor), by transmitting an electronic code from a mobile end device (e.g. a smartphone) by radio, or by entering a code at a numerical input device of the lock body, in particular to hereby simultaneously transmit an unlocking command and authentication information to the lock when the securing part is to be unlocked. In some applications, it is advantageous if no mechanical key is required to unlock the securing part. For example, in some applications it may also be desired to grant a user an unlocking authorization only temporarily and/or remotely. An authentication by radio may further simplify a management of the unlocking authorizations for a large number of locks of a user or of a user group.

A portable electronic lock comprising a securing part in the form of a substantially L-shaped hoop is known from DE 10 2018 111 305 A1, for example. A portable electronic lock comprising a securing part in the form of a substantially U-shaped hoop is known from DE 10 2019 113 184 A1, for example.

It is a problem with a portable electronic lock comprising an electromechanical locking device that such a lock is often used outdoors and is thus exposed to high mechanical loads and an entry of moisture and dirt. The sensor system installed in the lock may hereby suffer. With some electronic locks, there is also a problem in possible operating errors of the user, which may result in the lock not being correctly locked—unnoticed by the user. In some applications of portable electronic locks, there is also a problem that it is difficult to maintain the supply of electrical energy, whereby the securing function of the lock may be compromised.

It is an object of the invention to provide an electronic lock that has a robust design, which is suitable for mobile applications and which has a simple control, and that may still perform a securing function even when the energy supply is exhausted.

This object is satisfied by a portable electronic lock having the features of claim 1.

The lock has a lock body and a securing part (e.g. a hoop or a bolt; rigid, flexible or articulated). The securing part may be moved relative to the lock body between a closed position and an open position. In the open position, the securing part may in particular be partly released from the lock body such that the securing part and the lock body form an open loop, wherein the securing part, however, continues to be fixed to the lock body; the securing part may hereby, for example, be hung in at an object or placed around an object. In the closed position of the securing part, the securing part and the lock body may in particular form a closed loop and the lock may, for example, be used to secure an object to a stationary object. The lock body comprises an electromechanical locking device to selectively lock the securing part located in the closed position to the lock body. The electromechanical locking device has an electric motor, an entrainer, a rotating latch, a return spring, a blocking mechanism, and a control circuit for controlling the electric motor.

The entrainer may be driven by the electric motor to make a rotational movement between a starting position and a release position. For this purpose, the entrainer may, for example, be coupled directly or via a reduction gear unit to a rotor of the electric motor. So that the electric motor may drive the rotating latch via the entrainer, the rotating latch is drive-effectively coupled to the entrainer, but via a rotational clearance that at least corresponds to the angle of rotation of the entrainer during a movement between the starting position and the release position. The entrainer may thus also move between the starting position and the release position without driving the rotating latch, namely when the entrainer utilizes the rotational clearance, starting from a contact with the rotating latch. The rotating latch is preloaded by the return spring (e.g. a torsion spring) in the direction of a locking position in which the rotating latch locks the securing part located in the closed position to the lock body (directly or indirectly, for example, via an interposed blocking element).

Starting from the locking position of the rotating latch and starting from the starting position of the entrainer, the rotating latch may be electrically driven by the entrainer against the force of the return spring into an unlocking position, wherein the return spring is tensioned. In this unlocking position, the securing part is unlocked for a movement into the open position. The securing part may be manually moved into the open position or may be pretensioned by a release spring in the direction of the open position and may thus automatically jump into the open position as a result of the unlocking. As long as the securing part is in the open position, the blocking mechanism first blocks the rotating latch in the unlocking position against a return movement in accordance with its preload.

Such an unlocking is initiated by the control circuit in response to an unlocking command, wherein the control circuit rotates the entrainer from the starting position into the release position by appropriately controlling the electric motor. The unlocking command may be transmitted to the control circuit together with authentication information, or as an integral part of authentication information, for example in the form of a radio signal that may be transmitted (preferably as an encrypted signal) from a mobile end device of the user (e.g. a smartphone), in particular in accordance with a common protocol (e.g. Bluetooth, NFC).

The control circuit may, for example, comprise an integrated circuit (IC); a microprocessor; a central processing unit (CPU); or an application-specific integrated circuit (ASIC), in particular having an integrated non-volatile memory. The control circuit may also comprise the necessary driver electronics for the electric motor and the authentication sensor system that will still be mentioned below.

The control circuit is configured, after such an electrical driving of the rotating latch into the unlocking position, to rotate the entrainer—by appropriately controlling the electric motor—back into its starting position utilizing the rotational clearance, while the rotating latch is blocked in the unlocking position by the blocking mechanism, i.e. remains held in the unlocking position. Thereafter—and in particular independently of the control circuit—the blocking mechanism may be released in that the user moves the securing part from the open position into the closed position (for example, by inserting it into the lock body). Due to the release of the blocking mechanism, an unblocking of the rotating latch and thus a relaxing of the return spring are triggered so that the rotating latch is mechanically driven by the return spring to make a return movement into the locking position.

Thus, the electromechanical locking device is configured, as a result of a received electronic unlocking command, to unlock the securing part by electrically driving the rotating latch. In contrast, the subsequent locking of the securing part to the lock body takes place purely mechanically and is triggered by the user by manually moving the securing part.

Such an embodiment of the portable electronic lock enables a control sequence that requires no or only a simple position sensor system for the movable elements of the electromechanical locking device. For the driving of the rotating latch via the electric motor and the entrainer may take place in accordance with a predetermined time sequence as soon as an unlocking command is present. A position sensor for the entrainer may indeed be provided, for example, to prevent the electric motor from having to travel to mechanical end abutments (unwanted wear). However, for example, no position sensor is required for the securing part, in particular to recognize whether the securing part has been moved into the closed position. For the locking of the securing part may be triggered and performed purely mechanically without a monitoring by the control circuit being required. The lock is thus particularly robust with respect to malfunctions of position sensors that have to be installed in exposed positions (e.g. in an introduction passage of the lock body for the securing part, into which introduction passage moisture or dirt from the environment may easily move). Due to the mechanical triggering and execution of the locking, the user directly receives haptic feedback via the locking of the securing part that has taken place when the user moves the securing part from the open position into the closed position. Operating errors and in particular an overlooking of a locking that has not taken place or that has not taken place completely may hereby be avoided.

Furthermore, even if no electrical energy is available for the electric motor, the lock may still fulfill its securing function in that the securing part is moved from the open position into the closed position and is then automatically locked by a mechanical driving. For the driving of the rotating latch in the direction of the locking position is accomplished by the return spring, i.e. by a mechanical energy store. Thus, the lock may, for example, be stored in a stationary warehouse or a transport vehicle over a long period of time and may nevertheless be directly used for a securing of an object (by locking) even if an electrical energy store of the lock is exhausted (e.g. discharged).

Further embodiments are explained below.

In some embodiments, a mechanical end abutment may be provided (e.g. at a section of a housing of the lock body) for the rotational movability of the entrainer in at least one direction of rotation, wherein the control circuit may be configured to drive the entrainer via the electric motor to carry out a rotation up to the respective end abutment. The entrainer may abut against the respective end abutment to limit the rotational movement. In some embodiments, the control circuit may be configured to monitor the motor current of the electric motor, wherein the drive is ended as soon as an increase in the motor current is determined (which indicates that the entrainer has reached the respective end abutment).

Alternatively thereto, in some embodiments, the lock may have a position sensor that is configured to detect at least one rotational position of the entrainer. Such a position sensor may cooperate directly with the rotationally movable entrainer or may be effective at another position (for example, at the rotor within the electric motor or at a motor shaft outside the electric motor). In both cases, the position sensor may be arranged within the lock body, and in particular within a housing of the lock body, and may thus be well protected with respect to moisture and dirt. Such a position sensor does not necessarily have to output a position value (e.g. an angle of rotation), but it is generally sufficient if at least the reaching of a desired position is detected.

If at least one position sensor is present for both directions of rotation of the entrainer and/or a position signal is generated, the control circuit may be configured, in response to the unlocking command, to rotate the entrainer in the direction of the release position until the position sensor signals the reaching of the release position. The control circuit may optionally be configured to then wait for a predetermined waiting interval. The control circuit may be configured to thereafter rotate the entrainer back in the direction of the starting position until the position sensor signals the reaching of the starting position. A predetermined control sequence may hereby be followed, whereby it may be avoided that the electric motor always has to run against the end abutment.

In some embodiments, the position sensor may be configured as a switch. Thus, the position sensor may have a particularly simple and robust design.

In some embodiments, the entrainer of the electric motor may be rotationally fixedly connected to at least one cam. The cam or the cams may, for example, project in the radial direction or in the axial direction (with respect to the axis of rotation of the entrainer). The cam or the cams may, for example, be formed at a rotary disk that is rotationally fixedly connected to the entrainer. The electromechanical locking device may have at least one switch that may be actuated by the cam or the cams (in particular the switch already mentioned), wherein the control circuit may be configured to control the electric motor in dependence on a detected actuation of the switch(es). One or more cams may be formed at the rotationally movable entrainer with little effort and small space requirements, whereby a simple and reliable actuation of a respective switch is made possible in dependence on the rotational position of the entrainer.

In some embodiments, the entrainer may be rotationally fixedly connected to two cams that are spaced apart from one another in the direction of rotation, wherein the lock has a single switch that is actuated by one of the two cams in the starting position of the entrainer and that is actuated by the other of the two cams in the release position of the entrainer. Thus, only a single switch is required to signal the respective reaching of both the starting position and the release position of the entrainer to the control circuit.

In some embodiments, the switch or the switches may be configured to detect an actuation due to a movement of the at least one cam from a first direction of rotation and an actuation due to a movement of the at least one cam from a second direction of rotation opposite to the first direction of rotation and to distinguish said actuations from one another. Since the switch or the switches is/are direction-sensitive, the control circuit may determine the region of the current rotational position of the entrainer in the event of a restart (for instance, due to a functional disturbance as a result of a mechanical blocking or a failure of the energy supply) without having to approach mechanical end abutments.

In some embodiments, the switch may in particular have a rocker lever that, in dependence on the direction of rotation of the at least one cam (i.e. in dependence on the direction in which the switch is traveled over), may be actuated either in a first direction or in a second direction opposite thereto. The resulting lever positions of the rocker lever may be distinguished from one another in terms of signal technology.

In some embodiments, the rocker lever may be preloaded into a center position so that a disturbance-free traveling over of the rocker lever by the cam is possible from both directions of rotation.

In some embodiments, the center position of the rocker lever may be aligned in parallel with an axis of rotation of the cam(s). A compact design of the lock is hereby possible since only a small installation space is required radially outside the movement path of the cam(s) for the switch comprising the rocker lever.

In some embodiments, the switch may be configured to also distinguish the center position of the rocker lever from a respective actuation due to a movement of the cams(s) in the first or second direction of rotation. Thus, a total of three lever positions of the rocker lever may be distinguished from one another in terms of signal technology, wherein an intermediate position of the entrainer (between the starting position and the release position) may be directly recognized. This may simplify a restart (if this becomes necessary, for instance, due to a functional disturbance or a failure of the energy supply).

In some embodiments, said switch is the only position sensor which the lock comprises for detecting the rotational position of the entrainer of the electric motor, the rotational position of the rotating latch, and the position of the securing part. As explained, due to the specific design of the electromechanical locking device, no further position sensors are required that would involve an additional construction effort and that could be associated with a higher proneness to disturbance (in particular with respect to entering moisture or contamination).

As regards the blocking mechanism for the rotating latch in the unlocking position, the blocking mechanism may have a blocking section of the securing part that is in engagement with a blocking section of the rotating latch in the unlocking position of the rotating latch and in the open position of the securing part in order to block the rotating latch in the unlocking position. The securing part may further have an unblocking section that, when moving the securing part from the open position into the closed position, comes to lie at the rotating latch instead of the blocking section of the securing part and unblocks the rotating latch for the return movement in the direction of the locking position. Thus, a release of the blocking mechanism and thus a locking of the securing part to the lock body may be triggered in a simple manner by the user moving the securing part into the closed position and hereby moving the unblocking section of the securing part, instead of the blocking section, to the level of the rotating latch.

In some embodiments, the entrainer of the electric motor may, as already mentioned, be coupled to a rotor of the electric motor via a reduction gear unit. A sufficiently high torque may hereby be generated to drive the rotating latch into the unlocking position and to tension the return spring at the same time.

In some embodiments, the lock may have an authentication sensor system for acquiring authentication information, wherein the control circuit is configured to only execute the unlocking command when the acquired authentication information corresponds to an unlocking authorization, wherein the authentication sensor system comprises at least one of the following sensor systems:
a biometric sensor;
a radio communication device for receiving a radio signal; or
a code input device.

The lock may thus generally receive authentication information, which legitimizes the user for an unlocking, in different ways. The unlocking command may in particular be transmitted to the control circuit together with the authentication information or as an integral part of the authentication information. The control circuit may have a memory or be connected to a memory in which information about the unlocking authorization is stored. The control circuit may be configured to evaluate the received authentication information and in particular to compare the received authentication information with the stored information about the unlocking authorization and to execute the unlocking command only if there is a match. Instead of from a local memory, the information about the unlocking authorization may also be read out via radio from a remote memory (e.g. a cloud memory).

The biometric sensor may, for example, comprise a fingerprint sensor.

The radio communication device may be configured to receive the radio signal in accordance with a common protocol (e.g. Bluetooth, Near Field Communication NFC, Long Term Evolution LTE, or further developments thereof). The radio communication device may in particular be configured to receive the radio signal comprising the authentication information from a mobile end device of the user (e.g. a smartphone). The radio signal is preferably encrypted, wherein the control circuit may be configured to decrypt the radio signal and thus to extract the authentication information. The radio communication device may have a radio receiver. In some embodiments, the radio communication device may additionally have a radio transmitter to enable a bidirectional communication and, for example, to also transmit state information or confirmation signals.

The code input device may in particular comprise a numerical input device for inputting a character sequence (e.g. a key panel or a touch screen with virtual keys).

In some embodiments, the lock may have an electrical energy source for an energy supply of the electric motor and the control circuit, for example, a battery or a rechargeable battery.

Alternatively to or in addition to such an internal electrical energy source, in some embodiments, the lock may have at least one electrical terminal for receiving electrical energy for an energy supply of the electric motor and the control circuit. The electrical terminal may be configured to be selectively coupled to an electrical energy source from outside the lock body. Thus, the electromechanical locking device may be supplied with electrical energy from the outside, if necessary, in particular to unlock the securing part of the lock.

In an embodiment having an electrical terminal for an external electrical energy source, it is preferred if the electrical terminal is configured to only receive electrical energy for the electric motor and the control circuit, but no signals comprising authentication information. Instead, the authentication information that is, for example, required for an unlocking command is preferably transmitted to the control circuit via an interface of the lock that is separate from the electrical terminal. Thus, a relatively simple and inexpensive external electrical energy source may be provided and the user may hereby also provisionally stock a plurality of copies to ensure that he always has at least one sufficiently charged energy source. This may be important during mobile use when the user uses a plurality of locks of the same construction and, for example, has to locate and unlock them in a single trip. The required authentication may, in contrast, always be performed using the same device, in particular via the smartphone of the user that is typically always available.

In some embodiments, the securing part may, as already mentioned, be preloaded in the direction of the open position. For this purpose, a release spring may, for example, be provided that is supported at the lock body, on the one hand, and at the securing part, on the other hand.

In some embodiments, the entrainer may have a drive section that contacts or comes to lie at a drive section of the rotating latch when the entrainer is rotated, starting from the starting position, in the direction of the release position while the rotating latch is in the locking position. Thus, the entrainer may be drive-effectively coupled to the rotating latch via the drive section of the entrainer (e.g. the end face, step, edge, projection or the like) and the drive section of the rotating latch (e.g. complementary geometry) to drive the rotating latch and to tension the return spring at the same time. If the entrainer is rotated back from the release position into the starting position while the rotating latch is blocked by the blocking mechanism and remains in the unlocking position, the drive section of the entrainer may detach from the drive section of the rotating latch.

In some embodiments, the electromechanical locking device may have at least one blocking element via which the rotating latch cooperates with the securing part to lock the securing part to the lock body when the securing part is in the closed position and the rotating latch is in the locking position. The respective blocking element may, for example, have the shape of a sphere, a cylinder, an ellipsoid, a pin, a plate or a slider, in particular having rounded ends. The respective blocking element may in particular be movably supported in the lock body in the radial direction (with respect to the axis of rotation of the rotating latch). The respective blocking element may cooperate with drive surfaces of the rotating latch, in particular at a lateral surface of the rotating latch.

In some embodiments, the lock may be configured as a padlock, wherein the securing part is configured as a substantially U-shaped hoop. The U-shaped hoop may have two limbs that may in particular be aligned in parallel with one another. The two limbs may be of equal length or of different lengths. The electromechanical locking device is preferably configured to lock the two limbs in the closed position of the U-shaped hoop. For this purpose, the rotating latch may be configured, in the locking position, to engage into a recess of the respective hoop limb directly or via a respective blocking element of said kind. The securing part or the U-shaped hoop may hereby be particularly stably and reliably locked to the lock body.

The invention will be explained only by way of example in the following with reference to the drawings.

FIG. 1 shows a schematic representation of a portable electronic lock;

FIG. 2 shows an entrainer;

FIGS. 3A and 3B show a rotating latch in a locking position and an unlocking position, respectively; and

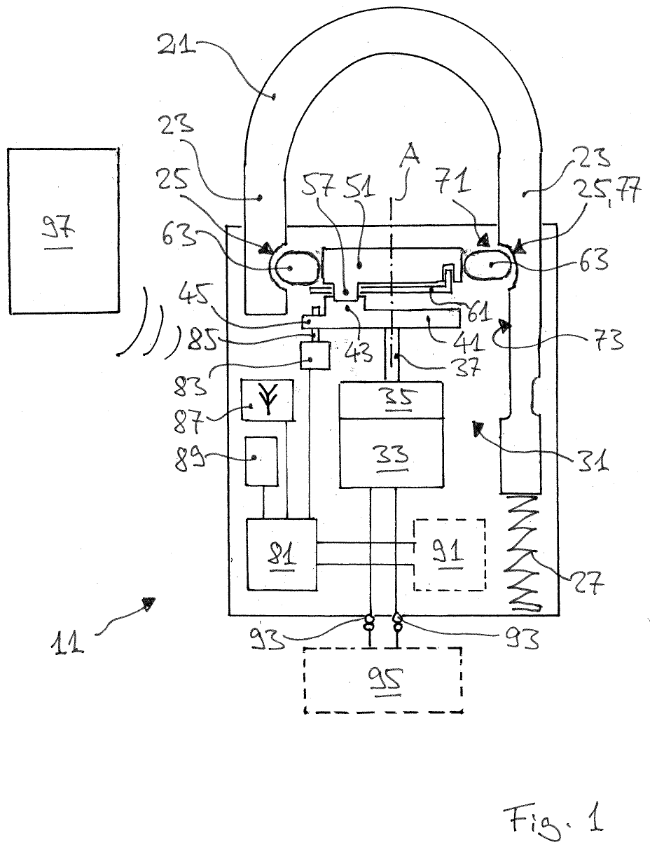

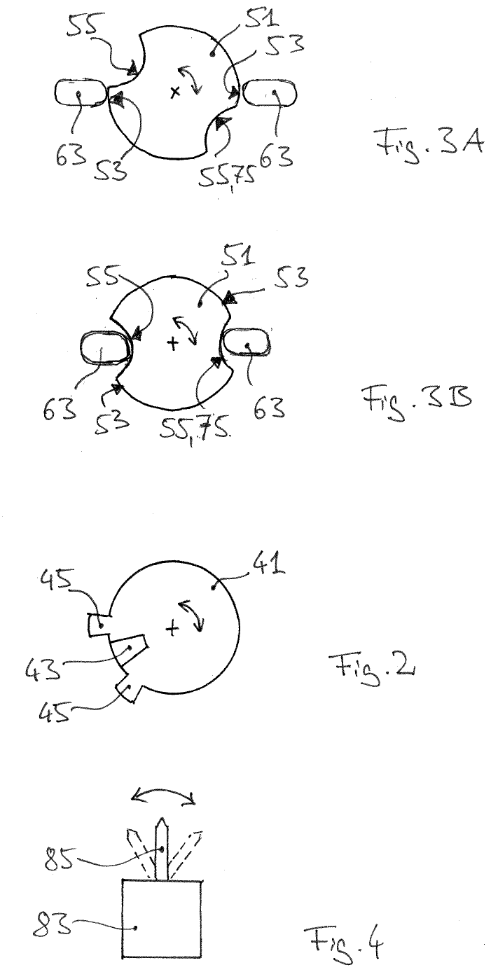

FIG. 4 shows a switch.

The portable electronic lock shown in FIG. 1 comprises a lock body 11 and a securing part in the form of a U-shaped hoop 21. The hoop 21 has two limbs 23 of different lengths. A locking recess 25 is formed at each of the two limbs 23. The hoop 21 may be moved relative to the lock body 11 between a closed position (as shown in FIG. 1) and an open position. In the open position, the free end of the shorter limb 23 is located outside the lock body 11 so that the hoop 21 may be placed around an object to be secured, wherein the free end of the longer limb 23 remains fixed in the lock body 11. The hoop 11 is preloaded by an ejection spring 27 in the direction of the open position.

The lock body 11 comprises an electromechanical locking device 31 that has an electric motor 33, a reduction gear unit 35 coupled to the electric motor 33, an output shaft 37, and an entrainer 41 rotatable about an axis of rotation A. The entrainer 41 is rotationally fixedly connected to the output shaft 37 of the reduction gear unit 35 and may thus be electrically driven by the electric motor 33 to make a rotational movement between a starting position and a release position. The entrainer 41 has the form of a rotary disk at which an axially upwardly projecting drive section 43 and two radially outwardly projecting cams 45 are formed that are spaced apart from one another in the direction of rotation with respect to the axis of rotation A of the entrainer 41, as can be seen from the plan view in accordance with FIG. 2.

The electromechanical locking device 31 further comprises a rotating latch 51 that is likewise rotatable about the axis of rotation A. The rotating latch 51 substantially has a cylindrical shape, wherein two mutually diametrically oppositely disposed locking sections 53 and two mutually diametrically oppositely disposed unlocking sections 55 are formed at a lateral surface of the rotating latch 51, wherein the unlocking sections 55 are radially inwardly concave with respect to the locking sections 53 (cf. the plan view in accordance with FIGS. 3A and 3B). An axially downwardly projecting drive section 57 is further formed at the rotating latch 51 and cooperates with the drive section 43 of the entrainer 41, as will be further explained below.

The electromechanical locking device 31 further comprises a return spring 61, which preloads the rotating latch 51 in the direction of a locking position, and two blocking elements 63. The return spring 61 is configured as a torsion spring that is spiral in a plan view. One end of the return spring 61 is fixed to the lock body 11 and another end of the return spring 61 is connected to the rotating latch 51. The blocking elements 63 are elongate with rounded ends. In the locking position of the rotating latch 51, which is shown in FIGS. 1 and 3A, the blocking elements 63 are urged radially outwardly by the locking sections 53 of the rotating latch 51 and engage into the locking recesses 25 of the hoop 21 to lock the hoop 21 to the lock body 11 in the closed position. In an unlocking position of the rotating latch 51, on the other hand, which is shown in FIG. 3B, the blocking elements 63 may move back radially inwardly into the concave unlocking sections 55 of the rotating latch 51 to unlock the hoop 21 and thus to release it for a movement into the open position (in FIG. 1, this is an upward movement). As can be seen from FIGS. 3A and 3B, the unlocking section 55 associated with the right blocking element 63 has a shallower depth than the unlocking section 55 associated with the left blocking element 63. The locking position and the unlocking position of the rotating latch 51 may, for example, differ by an angle that lies in a range between 30° and 60°.

The rotating latch 51 is coupled to the entrainer 41 via the respective drive sections 43, 57, wherein a rotational clearance exists between the rotating latch 51 and the entrainer 41. Thus, there is no rotationally fixed coupling. Starting from its starting position, the entrainer 41 may indeed drive the rotating latch 51 from the locking position into the unlocking position. However, as a result of the rotational clearance, after the entrainer 41 has rotated the rotating latch 51 into the unlocking position, the entrainer 41 may detach from the rotating latch 51 and may be rotated back into its starting position. For this purpose, the rotational clearance at least corresponds to the angle of rotation of the entrainer during a movement between the starting position and the release position.

The electromechanical locking device 31 further comprises a blocking mechanism 71 that comprises a blocking section 73 of the hoop 21, a blocking section 75 of the rotating latch 51, and an unblocking section 77 of the hoop 21. The blocking section 73 of the hoop 21 is formed by a flattened portion that extends downwardly along the inner side of the right hoop limb 23, starting from the locking recess 25. The blocking section 75 of the rotating latch 51 is formed by the right unlocking section 55 of the rotating latch 51. The unblocking section 77 of the hoop 21 is formed by the locking recess 25 of the right hoop limb 23.

When the rotating latch 51 adopts the unlocking position in accordance with FIG. 3B, the right blocking element 63 may sufficiently move back radially inwardly despite the shallower depth of the recess or of the right unlocking section 55 of the rotating latch 51 so that the hoop 21 may move upwardly into the open position. For the flattened portion or the blocking section 73 of the right hoop limb 23 is correspondingly offset radially outwardly (i.e. to the right in FIG. 1). In the open position of the hoop 21, the blocking section 73 of the hoop 21 is arranged at the level of the rotating latch 51. In the open position of the hoop 21, the right blocking element 63 also remains captured between the associated unlocking section 55 or the blocking section 75 of the rotating latch 51 that is hereby formed, on the one hand, and the blocking section 73 of the hoop 21, on the other hand. The rotating latch 51 is thus mechanically blocked in its unlocking position in accordance with FIG. 3B, in particular against a return movement by the tensioned return spring 61. However, if the hoop 21 is moved from the open position into the closed position in accordance with FIG. 1, the right blocking element 63 may move back radially outwardly into the associated locking recess 25 of the hoop 21 that forms the unblocking section 77 of the hoop 21. The rotating latch 51 is thus unblocked for a rotational movement into the locking position, i.e. the blocking mechanism 71 is released.

The electromechanical locking device 31 further comprises a control circuit 81 for controlling the electric motor 33, a position sensor in the form of a switch 83 that has a rocker lever 85, an authentication sensor system that has a radio communication device 87, and an electronic memory 89. The electromechanical locking device 31 may further comprise either an internal electrical energy source 91 or electrical terminals 93 for an external electrical energy source 95, or both. The lock may further be associated with a mobile end device 97 of the user (e.g. a smartphone with its own radio communication device and a corresponding software application or app). The control circuit 81 is connected to the switch 83, the radio communication device 87, the memory 89, the internal electrical energy source 91 (if present), and the electrical terminals 93 (if present).

The control circuit 81 is configured to control the lock, starting from a locked state, as follows:

Via the radio communication device 87, an authorized user (e.g. via their mobile end device 97) may transmit an encrypted radio signal to the lock (e.g. as a Bluetooth signal or an NFC radio signal). The radio signal includes an unlocking command and authentication information. The control circuit 81 compares the received authentication information with information about an unlocking authorization stored in the memory 89. In the case of a determined match, the unlocking command is executed.

To execute the unlocking command, the control circuit 81 controls the electric motor 33 to rotate the entrainer 41 from the starting position into the release position. The entrainer 41 hereby drives the rotating latch 51 via the drive sections 43, 57 to make a rotational movement from the locking position into the unlocking position, wherein the return spring 61 is simultaneously tensioned. On reaching the unlocking position of the rotating latch 51, the hoop 21 is unlocked and may be moved from the closed position into the open position by the ejection spring 27.

The blocking mechanism 71 blocks the preloaded rotating latch 51 in the unlocking position as explained above.

The control circuit 81 only allows a short waiting interval to elapse (e.g. with a time duration in the range from 0.2 seconds to 2 seconds) and then controls the electric motor 33 to rotate the entrainer 41 back into its starting position utilizing the explained rotational clearance (relative to the rotating latch 51).

Only when the user moves the hoop 21 from the open position in the direction of the lock body 11 into the closed position again, the blocking mechanism 71 is released as explained so that the rotating latch 51 is unblocked. A relaxing of the return spring 61 is thus triggered so that the rotating latch 51 is now mechanically driven back into the locking position by the return spring 61. In this respect, the drive section 57 of the rotating latch 51 comes into contact with the drive section 43 of the entrainer 41 or is stopped shortly before by an abutment (not shown).

Due to the rotation of the rotating latch 51 back into the locking position, the blocking elements 63 are urged radially outwardly and the hoop 21 is locked to the lock body 11 again. This mechanical locking may take place directly after the unlocking (after the entrainer 41 has been rotated back into its starting position) or at any desired later point in time, and indeed independently of a supply of electrical energy to the electric motor 33 and the control circuit 81.

To move the entrainer 41 with positional accuracy and to control the electric motor 33 accordingly, the control circuit 81 receives corresponding position signals from the switch 83 that represent the reaching of the release position or the starting position of the entrainer 41. Thus, the control circuit 81 may rotate the entrainer 41 in the direction of the release position until the switch 83 signals the reaching of the release position; the control circuit 81 may then wait for the predetermined waiting interval; and the control circuit 81 may thereafter rotate the entrainer 41 back in the direction of the starting position until the switch 83 signals the reaching of the starting position.

For this purpose, the switch 83 detects whether the rocker lever 85 is traveled over by the one or the other of the two cams 45 of the entrainer 41 (cf. FIG. 2) and is thus flipped in the respective direction. FIG. 4 shows the switch 83, wherein the rocker lever 85 is shown in solid lines in a center position. The rocker lever 85 is preloaded into this center position. The respective position of the rocker lever 85 is shown in dashed lines when the rocker lever 85 is thrown in the one direction or the other direction. These two positions may be distinguished from one another in a technical signal manner so that the switch 83 provides a direction-sensitive signal with respect to the rotational movement of the entrainer 41.

With respect to the authentication sensor system described, the lock may also, for example, have a biometric sensor (e.g. a fingerprint sensor) or a code input device instead of the radio communication device 87.

For the supply of electrical energy to the electric motor 33 and the control circuit 81, the lock may, as explained, have an internal electrical energy source 91.

However, in some applications, it may be advantageous if the lock is equipped with electrical terminals 93 that are accessible from the outside and that make it possible to connect an external electrical energy source 95 (e.g. a battery or a rechargeable battery). The energy supply may hereby take place, if required, wherein it is generally sufficient if the user takes along a relatively simple external electrical energy source 95. This may be correspondingly inexpensive to manufacture so that the user may also keep a plurality of such external energy sources 95 to ensure that he always has a charged external energy source 95. Due to such an external energy source 95, it may also be ensured that the energy required for the explained tensioning of the return spring 61 may always be provided. In contrast, the user may, as explained, perform the authentication for an unlocking of the lock via a separate channel. The interface required for this purpose (radio signals or electrical signals) is namely typically much more complex than a pure energy supply. In an embodiment having electrical terminals 93 for an external electrical energy source 95, an internal electrical energy source 91 may be completely omitted or an internal electrical energy source 91 may be additionally provided (e.g. as a buffer).

One advantage of the portable electronic lock shown in FIGS. 1 to 4 is a stable control sequence that only requires a simple position sensor system for the movable elements of the electromechanical locking device 31. The driving of the rotating latch 51 via the electric motor 33 and the entrainer 41 may take place in accordance with a predetermined control sequence as soon as an unlocking command is present. The switch 83 may be arranged well protected from moisture and dirt in the interior of the lock body 11. Since the locking of the hoop 21 is triggered and performed purely mechanically, no additional sensor is required for monitoring the position of the hoop 21. Due to the mechanical triggering and execution of the locking, the user, when he moves the securing part from the open position into the closed position, immediately receives haptic feedback via the locking of the securing part that has taken place, whereby operating errors may be easily avoided. Furthermore, even if no electrical energy is available for the electric motor, the lock may then still be locked in order to fulfil the desired securing function, namely in that the securing part is moved from the open position into the closed position and is then automatically locked by a mechanical driving.

### REFERENCE NUMERAL LIST

11 lock body
21 securing part, hoop
23 limb
25 locking recess
27 ejection spring
31 electromechanical locking device
33 electric motor
35 reduction gear unit
37 output shaft
41 entrainer
43 drive section of the entrainer
45 cam
51 rotating latch
53 locking section of the rotating latch
55 unlocking section of the rotating latch
57 drive section of the rotating latch
61 return spring
63 blocking element
71 blocking mechanism
73 blocking section of the securing part
75 blocking section of the rotating latch
77 unblocking section of the securing part
81 control circuit
83 position sensor, switch
85 rocker lever
87 authentication sensor system, radio communication device
89 memory
91 electrical energy source
93 electrical terminal for the energy supply
95 external electrical energy source
97 mobile end device
A axis of rotation of the entrainer and the rotating latch

1. A portable electronic lock, comprising a lock body and a securing part that is movable relative to the lock body between a closed position and an open position, wherein the lock body comprises an electromechanical locking device that has an electric motor, an entrainer, a rotating latch, a return spring, a blocking mechanism, and a control circuit for controlling the electric motor,
wherein the entrainer can be driven by the electric motor to make a rotational movement between a starting position and a release position,
wherein the rotating latch is coupled to the entrainer with a rotational clearance that at least corresponds to the angle of rotation of the entrainer during a movement between the starting position and the release position, wherein the rotating latch is preloaded by the return spring in the in a direction of a locking position in which the securing part located in the closed position is locked to the lock body,
wherein the rotating latch, starting from its locking position and starting from the starting position of the entrainer, can be driven by the entrainer against the force of the return spring into an unlocking position in which the securing part is unlocked for a movement into the open position,
wherein the blocking mechanism is configured to mechanically block the rotating latch in the unlocking position against a return movement by the return spring as long as the securing part is in the open position,
wherein the control circuit is configured, in response to an unlocking command, to rotate the entrainer from the starting position into the release position in order to electrically drive the rotating latch into the unlocking position and to tension the return spring, and to then rotate the entrainer back into its starting position utilizing the rotational clearance while the rotating latch is blocked in the unlocking position by the blocking mechanism,
wherein, by moving the securing part from the open position into the closed position, the blocking mechanism can be is released to trigger an unblocking of the rotating latch and thus a relaxing of the return spring so that the rotating latch can be is mechanically driven by the return spring to make a return movement into the locking position.

2. A portable electronic lock in accordance with claim 1,
wherein the lock has a position sensor that is configured to detect at least one rotational position of the entrainer.

3. A portable electronic lock in accordance with claim 2,
wherein the control circuit is configured, in response to the unlocking command, to rotate the entrainer in the direction of the release position until the position sensor signals the reaching of the release position; to then wait for a predetermined waiting interval; and to thereafter rotate the entrainer back in the direction of the starting position until the position sensor signals the reaching of the starting position.

4. A portable electronic lock in accordance with claim 1,
wherein the entrainer of the electric motor is rotationally fixedly connected to at least one cam and the lock has at least one switch that can be actuated by the at least one cam, wherein the control circuit is configured to control the electric motor in dependence on an actuation of the at least one switch.

5. A portable electronic lock in accordance with claim 4,
wherein the entrainer is rotationally fixedly connected to two cams that are spaced apart from one another in the direction of rotation, wherein the lock has a single switch that is actuated by one of the two cams in the starting position of the entrainer and that is actuated by the other of the two cams in the release position of the entrainer.

6. A portable electronic lock in accordance with claim 4,
wherein the at least one switch is configured to detect an actuation due to a movement of the at least one cam from a first direction of rotation and an actuation due to a movement of the at least one cam from a second direction of rotation opposite to the first direction of rotation and to distinguish said actuations from one another.

7. A portable electronic lock in accordance with claim 4,
wherein the at least one switch has a rocker lever that, in dependence on the direction of rotation of the at least one cam, can be actuated either in a first direction or in a second direction opposite thereto.

8. A portable electronic lock in accordance with claim 7,
wherein the rocker lever is preloaded into a center position.

9. A portable electronic lock in accordance with claim 8,
wherein the center position of the rocker lever is aligned parallel to an axis of rotation of the cam.

10. A portable electronic lock in accordance with claim 8,
wherein the at least one switch is configured to also detect the center position of the rocker lever and to distinguish said center position from a respective actuation of the rocker lever due to a movement of the at least one cam-in the first or second direction of rotation.

11. A portable electronic lock in accordance with claim 4,
wherein said at least one switch is the only position sensor which the lock comprises for detecting the rotational position of the entrainer of the electric motor, the rotational position of the rotating latch, and the position of the securing part.

12. A portable electronic lock in accordance with claim 1,
wherein the blocking mechanism has a blocking section of the securing part that is in engagement with a blocking section of the rotating latch in the unlocking position of the rotating latch and in the open position of the securing part in order to block the rotating latch in the unlocking position, wherein the securing part has an unblocking section that, when moving the securing part from the open position into the closed position, comes to lie at the rotating latch instead of the blocking section of the securing part and unblocks the rotating latch for the return movement.

13. A portable electronic lock in accordance with claim 1,
wherein the lock has an authentication sensor system for acquiring authentication information, wherein the control circuit is configured to only execute the unlocking command when the acquired authentication information corresponds to an unlocking authorization, wherein the authentication sensor system comprises at least one of the following sensor systems:
a biometric sensor;
a radio communication device for receiving a radio signal; and/or
a code input device.

14. A portable electronic lock in accordance with claim 1,
wherein the lock has an electrical energy source for an energy supply of the electric motor and the control circuit.

15. A portable electronic lock in accordance with claim 1,
wherein the lock has at least one electrical terminal for receiving electrical energy for an energy supply of the electric motor and the control circuit, wherein the electrical terminal is configured to be selectively coupled to an electrical energy source from outside the lock body.

16. A portable electronic lock in accordance with claim 15,
wherein the electrical terminal is configured to only receive electrical energy for an energy supply of the electric motor and the control circuit, wherein the lock has an interface for receiving authentication information, said interface being separate from the electrical terminal.

17. A portable electronic lock in accordance with claim 1,
wherein the securing part is preloaded in the direction of the open position.

18. A portable electronic lock, comprising a lock body and a securing part that is movable relative to the lock body between a closed position and an open position, wherein the lock body comprises an electromechanical locking device that has an electric motor, an entrainer, a rotating latch, a return spring, a blocking mechanism, and a control circuit for controlling the electric motor,
wherein the electric motor drives the entrainer for a rotational movement between a starting position and a release position,
wherein the rotating latch is coupled to the entrainer with a rotational clearance that at least corresponds to the angle of rotation of the entrainer during a movement between the starting position and the release position, wherein the rotating latch is preloaded by the return spring in a direction of a locking position in which the securing part located in the closed position is locked to the lock body, wherein the rotating latch, starting from its locking position and starting from the starting position of the entrainer, can be driven by the entrainer against the force of the return spring into an unlocking position in which the securing part is unlocked for a movement into the open position,
wherein the blocking mechanism is configured to mechanically block the rotating latch in the unlocking position against a return movement by the return spring as long as the securing part is in the open position,
wherein the control circuit is configured, in response to an unlocking command, to rotate the entrainer from the starting position into the release position in order to electrically drive the rotating latch into the unlocking position and to tension the return spring, and to then rotate the entrainer back into its starting position utilizing the rotational clearance while the rotating latch is blocked in the unlocking position by the blocking mechanism,
wherein, by moving the securing part from the open position into the closed position, the blocking mechanism is released for an unblocking of the rotating latch and thus a relaxing of the return spring so that the rotating latch is mechanically driven by the return spring to make a return movement into the locking position; wherein the electromechanical locking device comprises at least one cam fixed for rotation with the entrainer;
wherein the electromechanical locking device comprises a switch that is actuated by the at least one cam, wherein the control circuit controls the electric motor in dependence on an actuation of the switch;
wherein the switch has a rocker lever that is preloaded into a center position and that, in dependence on a direction of rotation of the at least one cam, is actuated by the at least one cam either in a first direction or in a second direction opposite thereto.

19. A portable electronic lock in accordance with claim 18,
wherein the rocker lever is aligned parallel to an axis of rotation of the cam when the rocker lever is in the center position.

20. A portable electronic lock, comprising a lock body and a securing part that is movable relative to the lock body between a closed position and an open position, wherein the lock body comprises an electromechanical locking device that has an electric motor, an entrainer, a rotating latch, a return spring, a blocking mechanism, and a control circuit for controlling the electric motor,
wherein the electric motor drives the entrainer for a rotational movement between a starting position and a release position,
wherein the rotating latch is coupled to the entrainer with a rotational clearance that at least corresponds to the angle of rotation of the entrainer during a movement between the starting position and the release position, wherein the rotating latch is preloaded by the return spring in a direction of a locking position in which the securing part located in the closed position is locked to the lock body, wherein the rotating latch, starting from its locking position and starting from the starting position of the entrainer, can be driven by the entrainer against the force of the return spring into an unlocking position in which the securing part is unlocked for a movement into the open position,
wherein the blocking mechanism is configured to mechanically block the rotating latch in the unlocking position against a return movement by the return spring as long as the securing part is in the open position,
wherein the control circuit is configured, in response to an unlocking command, to rotate the entrainer from the starting position into the release position in order to electrically drive the rotating latch into the unlocking position and to tension the return spring, and to then rotate the entrainer back into its starting position utilizing the rotational clearance while the rotating latch is blocked in the unlocking position by the blocking mechanism,
wherein, by moving the securing part from the open position into the closed position, the blocking mechanism is released for an unblocking of the rotating latch and thus a relaxing of the return spring so that the rotating latch is mechanically driven by the return spring to make a return movement into the locking position; wherein the electromechanical locking device comprises at least one cam fixed for rotation with the entrainer;
wherein the electromechanical locking device comprises a switch that has a rocker lever actuated by the at least one cam;
wherein the rocker lever is flipped by the at least one cam, depending on a movement of the at least one cam in a first direction of rotation or a movement of the at least one cam in a second direction of rotation opposite to the first direction of rotation, either in the first direction or in the second direction;
wherein the control circuit controls the electric motor in dependence on an actuation of the switch, wherein the control circuit distinguishes between the first direction and the second direction into which the rocker lever is flipped.
